(19) United States
(12) Patent Application Publication
(10) Pub. No.: US 2026/0044129 A1
(43) Pub. Date: Feb. 12, 2026

(54) Ethernet-APL Gateway

(71) Applicant: Siemens Aktiengesellschaft, Muenchen (DE)

(72) Inventors: Wilhelm GRIESBAUM, Landau (DE); Markus SAGERT, Karlsruhe (DE)

(21) Appl. No.: 19/291,761

(22) Filed: Aug. 6, 2025

(30) Foreign Application Priority Data
Aug. 7, 2024 (EP) 24193365

(51) Int. Cl. G05B 19/042; H04L 12/40

(52) U.S. Cl. CPC G05B 19/0423; H04L 12/40; H04L 2012/40221

(57) ABSTRACT

A device includes a plurality of interfaces for Ethernet-APL-and PROFINET-based connection to field devices of an industrial plant, in particular a process or manufacturing plant, and includes an interface for PROFINET-based connection to a higher-level automation device of the industrial plant, wherein the device is configured to serve as a communication switch between the higher-level automation device and the field devices, where the device is further configured to serve as a PROFINET IO device in the context of the connection to the higher-level automation device, and to serve as a PROFINET IO controller in the context of the connection to the field devices, to serve as an Ethernet-APL gateway in the context of the connections to the field devices and the higher-level automation device.

### BACKGROUND OF THE INVENTION

### 1. Field of the Invention

The invention relates to an automation device, a method for operating an industrial plant, in particular a manufacturing or process plant and relates to a device that has a plurality of interfaces for Ethernet-APL-and PROFINET-based connection to field devices of the industrial plant, in particular the process or manufacturing plant, and that has an interface for PROFINET-based connection to a higher-level automation device of the industrial plant, where the device is configured to serve as a communication switch between the higher-level automation device and the field devices.

### 2. Description of the Related Art

It is to be assumed that Ethernet-APL (advanced physical layer) will become ever more prevalent in process industries, because its advantages are significant: although the final meters to the field device are connected by Ethernet technology, markedly higher communication performance may be achieved than with HART, for example.

In current designs, field devices are independent bus nodes and lead, for example, in the case of PROFINET, to a large number of nodes in the automation system. The problem with conventional automation devices, such as the AS410 from SIEMENS, is that they cannot map the same quantity framework of field devices in PROFINET-APL, or can do so only with major effort, as is currently possible with HART or PROFIBUS. This is primarily due to the additional communication and computational effort that the PROFINET-APL devices create in the automation device.

In automation technology, “APL switches” are known, which are arranged between the individual APL-capable field devices and a higher-level automation device. DE 10 2021 101 498 A1 discloses such an APL switch. There, each field device has a logical link directly to the automation device, which results in a high level of communication and computational effort for the automation device.

### SUMMARY OF THE INVENTION

It is an object of the present invention to enhance the efficiency of communication between a automation device and field devices using APL.

This and other objects and advantages are achieved in accordance with the invention by a device, an automation system, a method for operating an industrial plant and a method of operating an industrial plant, where the device in accordance with the invention has a plurality of interfaces for PROFINET-based connection to field devices of an industrial plant, in particular a process or manufacturing plant, and has an interface for PROFINET-based connection to a higher-level automation device of the industrial plant, where the device is configured to serve as a communication switch between the higher-level automation device and the field devices, where the device is further configured to serve as a PROFINET IO device in the context of the connection to the higher-level automation device, and to serve as a PROFINET IO controller, including a processor and memory, in the context of the connection to the field devices, and where the device is further configured to serve as an Ethernet-APL gateway in the context of the connections to the field devices and the higher-level automation system.

The industrial plant may be a process industry plant, such as a chemical, pharmaceutical or petrochemical plant or a plant from the food and beverage industry. Included herein are any plants from the production industry, i.e., factories in which, for example, automobiles or goods of all types are produced. Industrial plants that are suitable for implementing the method in accordance with the invention may also belong to the field of energy generation. Wind turbines, solar installations or power stations for energy generation are likewise covered by the term “industrial plant”.

The automation device may, like the device, form part of a control system that serves in automating the industrial plant. In the present context, a control system is understood to be a computer-assisted industrial system that comprises display, operating and control functionalities for the industrial plant. The control system may also comprise sensors for determining measured values and various actuators. In addition, the control system may comprise what are known as process-or manufacturing-oriented components that serve to drive the actuators or sensors. Furthermore, the control system may inter alia have a way to visualize the process engineering plant and to perform engineering. The control system may optionally also comprise further computing units for more complex control operations and systems for data storage and processing.

A field device is understood to be a technical facility in the domain of automation technology that is directly related to a production process, the term “field” denoting an area outside switchgear cabinets and control rooms. Field devices may be both actuators (e.g., control elements and/or valves) and sensors (measuring transducers) in factory and process automation.

The device in accordance with the invention has a plurality of interfaces, via which the field devices can be connected to the device. These interfaces are interfaces based on Ethernet-APL and PROFINET, which are in turn based on the Ethernet standard. In this context, PROFINET (short for process field network) constitutes an open industrial Ethernet standard from the PROFIBUS Nutzerorganisation e.V. (PNO, PROFIBUS user organization) for automation. APL stands for “advanced physical layer” and constitutes a further development of physical data transmission in Ethernet networks. It is possible to exchange Ethernet data between the field devices and the device via in each case two wires.

The interface between the device and the higher-level automation device is based on PROFINET. Here, Ethernet specifications may also be applied for the physical transmission layer.

The device is configured, in a manner known per se, to serve as a communication switch between the higher-level automation device and the field devices. The device accordingly constitutes a type of hub that forwards data packets that are exchanged bidirectionally between the automation device and the field devices to the correct destination address (for example, IP address).

In accordance with the invention, the device is configured to serve as a PROFINET IO device in the context of the connection to the higher-level automation device and to serve as a PROFINET IO controller in the context of the connection to the field devices. In other words, this means that the device serves, in its connection to the automation device, as a “PROFINET device” and in its connections to the field devices in each case as a “PROFINET master”. As a result, each APL-capable field device can have a direct logical connection to the device acting as a PROFINET master, where each physical transmission is based on Ethernet-APL. With regard to the automation device, the device behaves as a single device, so significantly reducing data traffic between the automation device and the device compared to a situation in which the device is a conventional communication switch in accordance with the prior art. In contrast, the device in accordance with the invention functions as an Ethernet-APL gateway in the context of the connections to the field devices and the higher-level automation device. The term “gateway” here implies that the data forwarded by the device (emanating either from the automation device or from the field devices) is processed in terms of (target) addressing by the device for forwarding purposes.

The APL gateway functionality in accordance with the invention, in conjunction with a functionality as a communication switch, reduces the communication and computing load on the (central) automation device. As a result, the automation device can be used for a larger part of the industrial plant. The connection to the individual field devices is managed by the device. The fully integrated solution of gateway and switch in one device simplifies integration into larger projects and configurability in the context of system engineering of the industrial plant, for example with the assistance of SIMATIC PCS 7 or PCS neo from SIEMENS.

The requirements for data transmission between the device and the automation device may be relatively low, for which reason the interface for connection to the higher-level automation device of the industrial plant can be configured based on PROFINET conformance class A. Requirements between the field devices and the device may be more stringent, in particular due to explosion protection, for which reason the interfaces for connection to the field devices may be configured based on PROFINET conformance class B.

The automation device may be a programmable logic controller, in particular a SIMATIC S7-410 from SIEMENS. The programmable logic controller can implement specific functions, such as sequential control, such that both input and output signals from processes and machines can be controlled.

In the context of one advantageous embodiment of the invention, it is possible via an appropriate input via a user interface of the device to predefine the conditions under which an Hypertext transfer protocol secure (HTTPS) connection from the automation device to the field devices is enabled. In other words, a security application can be implemented on the device that can specifically block or allow data packets through the device, in order, for example, to enable HTTPS connections for web management of the field devices only when required.

The device preferably has an aggregator functionality in order to enable filtering of the data sent by the field devices to the automation device. As a result, specific data can, for example, be filtered out and not forwarded to the automation device in order not to place an unnecessary load on its processing capacity.

The aggregator functionality may involve a neural network or a comparable method.

The device particularly preferably has a controller optimization functionality in order to preprocess the data sent by the field devices to the automation device in preparation for subsequent controller optimization to be implemented in the automation device.

Of the plurality of interfaces to the field devices, at least one interface can be configured as a current-loop interface to enable connection to a field device based on an electrical current with a current intensity of between 4 and 20 mA received by the field device.

The connection of this interface to the field device may preferably be configured based on the HART protocol. Data transmission between the field device in question and the device occurs by frequency-shift keying (FSK) in accordance with the Bell 202 standard. A high-frequency oscillation (±0.5 mA) is superimposed on the low-frequency analog signal. A digital “1” is represented by the 1.2 kHz (1200 Hz) frequency and a “0” by the 2.2 kHz (2200 Hz) frequency.

The above-stated object and advantages are additionally achieved in accordance with the invention by an automation system having a automation device and a device, where a disconnectable connection is made between the automation device and the PROFINET-based device. The phrase “disconnectable connection” means that the connection is not permanent (soldered/wired or the like) but can be made reversibly, for example, by plugging into a plug connection. The automation device and the device are to be considered physically separate components that are preferably arranged in rooms that are separate from one another.

The automation system preferably comprises a plurality of field devices that are disconnectably connected to the corresponding interfaces of the device. With regard to term “disconnectable”, reference is made to the definition in the preceding paragraph.

The automation system may additionally comprise an operating and monitoring system, such as an operator station server and an operator station client. In this case, the latter is connected to the automation device via a plant bus. The plant bus may, without limitation thereto, for example, be configured as an industrial Ethernet. The operator station client is configured to generate visual representations that it has received from the operator station server and that are used for operating and monitoring the industrial plant.

The above-stated objects and advantages are additionally achieved in accordance with the invention by a method for operating an industrial plant, in particular a manufacturing or process plant, having a device that is configured in the above-described manner.

The above-stated objects and advantages are further achieved in accordance with the invention by a method for operating an industrial plant, in particular a manufacturing or process plant, having an automation system that is configured in the above-described manner.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described characteristics, features and advantages of this invention and the manner in which these are achieved will become more clearly and distinctly comprehensible from the following description of exemplary embodiments that are explained in greater detail in connection with the drawings, in which:

FIG. 1 shows a schematic representation of an automation system in accordance with the invention; and

FIG. 2 shows a schematic representation of a device in accordance with the invention.

### DETAILED DESCRIPTION OF THE EXEMPLARY EMBODIMENTS

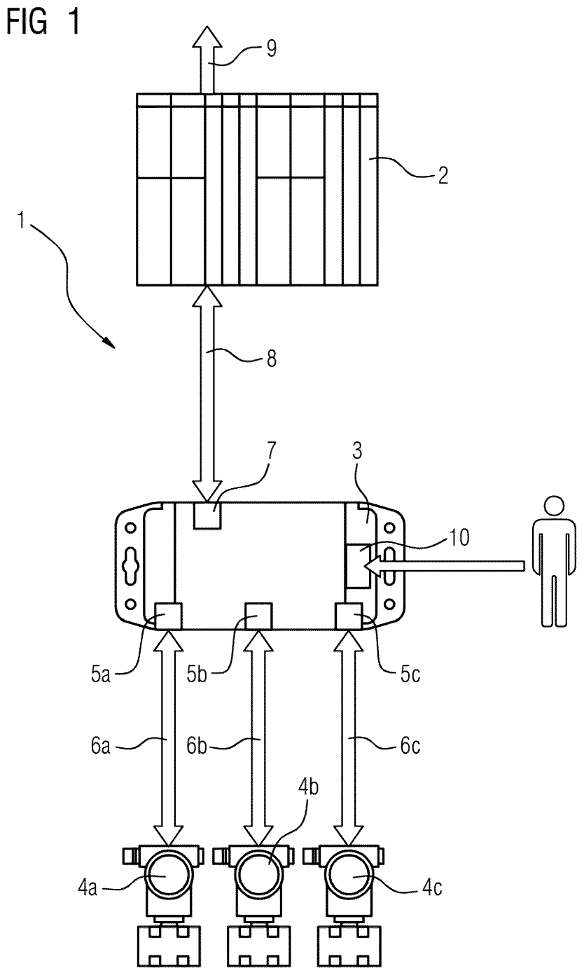

FIG. 1 is a schematic representation of an automation system 1 for a process plant or a manufacturing plant. The automation system 1 comprises a automation device 2, a device 3 and a plurality of field devices 4a, 4b, 4c. The field devices 4a, 4b, 4c are, for example, configured as sensors or actuators.

The device 3 has a plurality of interfaces 5a, 5b, 5c, each of which is disconnectably connected to one of the field devices 4a, 4b, 4c. A connection 6a, 6b, 6c of the interfaces 5a, 5b, 5c of the device 3 to the field devices 4a, 4b, 4c is in each case made based on Ethernet-APL and PROFINET.

The device 3 additionally has an interface 7 that is connected to the automation device 2 via a PROFINET-based disconnectable connection 8. The automation device 2 is configured as a programmable logic controller upon which an automation program that drives and evaluates the field devices 4a, 4b, 4c is executed. The automation device 2 has a connection 9 to an operating and monitoring system, for example, an operator station server and an operator station client (not shown) connected thereto.

The device 3 is configured to serve as a PROFINET IO device in the context of the connection 8 to the higher-level automation device 2. The term “PROFINET” here denotes “process field network”. This is an open standard for industrial Ethernet that is managed by Profibus & Profinet International (PI) and PROFIBUS-Nutzerorganisation e.V. (PNO). Transmission is based on Ethernet and Transmission Control Protocol/Internet Protocol (TCP/IP). Data communication within PROFINET follows a provider-consumer model, where the higher-level automation device 2 is in the present case the provider or IO controller as defined in PROFINET, while the device 3 for the connection 8 to the automation device 2 is the consumer or IO device as defined in PROFINET.

The interface 7 for connection 8 to the higher-level automation device 2 of the industrial plant is based on PROFINET conformance class A. PROFINET conformance class A (CC-A) is the simplest class and has the smallest range of functions. It includes real-time communication and supports standard TCP/IP functionalities and basic functions such as topology information.

The device 3 is furthermore configured to serve in each case as a PROFINET IO controller, including a processor and memory, in the context of the connections 6a, 6b, 6c to the field devices 4a, 4b, 4c. For these connections 6a, 6b, 6c, the field devices 4a, 4b, 4c accordingly server as IO devices as defined in PROFINET. The interfaces 5a, 5b, 5c for connection 6a, 6b, 6c to the field devices 4a, 4b, 4c are configured based on PROFINET conformance class B. Function class B includes the functions of class A (see previous explanation) and additionally comprises network diagnostics and topology detection functionalities.

Owing to the previously explained nature of its interfaces 7, 5a, 5b, 5c, the device 3 functions as an Ethernet-APL gateway for the field devices 4a, 4b, 4c connected to the device 3. This means that the field devices 4a, 4b, 4c turn to the device 3 for communication with the automation system 2 that, as a gateway, in turn processes and converts the requests and transfers them to the automation device 2. In contrast with conventional devices, such as APL switches, the field devices 4a, 4b, 4c therefore do not communicate directly with the automation device 2, so making data exchange between the field devices 4a, 4b, 4c and the automation device 2 more efficient and less onerous.

The device 3 has a user interface 10 via which it is possible by appropriate input to predefine the conditions under which an HTTPS connection from the automation device 2 to the field devices 4a, 4b, 4c is enabled. This increases the security of the connections 8, 6a, 6b, 6c to the field devices 4a, 4b, 4c.

The device 3 additionally has an aggregator functionality to enable filtering of the data sent by the field devices 4a, 4b, 4c to the automation device 2. This aggregator functionality is based on the involvement of a neural network. Prefiltering can reduce the communication load and/or workload on the automation device 2.

The device 3 moreover has a controller optimization functionality in order to preprocess the data sent by the field devices 4a, 4b, 4c to the automation device 2 in preparation for subsequent controller optimization to be carried out in the automation device 2. This also reduces the workload on the automation device 2.

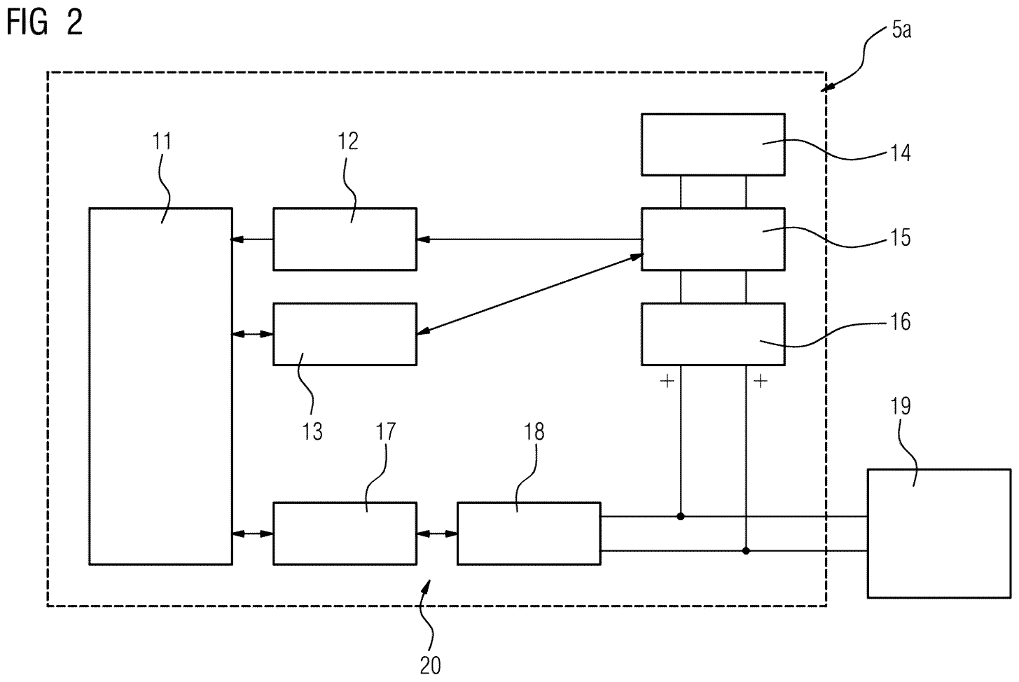

One interface 5a of the interfaces 5a, 5b, 5c is in the present case configured as a current-loop interface, further details of which are provided in the description relating to FIG. 2, where this figure shows a schematic structure of the interface 5a of the device 3. The interface 5a comprises a processing unit 11, an analog-digital converter 12, a HART circuit block 13, a DC voltage source 14, an current measurement facility 15, a low-pass filter 16, an APL unit 17, and a termination network 18.

The interface 5a can be used, on the one hand, as a per se known APL interface for an APL-capable field device 19. An APL channel 20 comprising the APL unit 17, the termination network 18, the DC voltage source 14 and the low-pass filter 16 is used for this purpose.

The interface 5a is also configured as a current-loop interface, also known as a 4 . . . 20 mA interface. For this purpose, the current measurement facility 15 measures the current with a magnitude of between 4 and 20 mA impressed by the field device 19. The analog-digital converter 12 converts the measured current value into a digital signal value and transmits it to the processing unit 11 for further processing. Data impressed by the field device 19 in accordance with the HART protocol on the current signal between the field device 19 and the device 3 can also be decoded and further processed. In the reverse direction, the HART circuit block 13 generates corresponding modulations for HART protocol-based communication toward the field device 19.

Although the invention has been illustrated and described in detail with reference to the preferred exemplary embodiment, the invention is not restricted by the disclosed examples and other variations may be derived therefrom by a person skilled in the art without departing from the scope of protection of the invention.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A device comprising:
a plurality of interfaces for Ethernet-advanced physical layer (Ethernet-APL) and PROFINET-based connection to field devices of an industrial plant comprising a process or manufacturing plant; and
an interface for PROFINET-based connection to a higher-level automation device of the industrial plant;
wherein the device is configured to serve as a communication switch between the higher-level automation device and the field devices; and
wherein the device is further configured to serve as a PROFINET IO device in contexts of the connection to the higher-level automation device, and to serve as a PROFINET IO controller in contexts of the connection to the field devices to function as an Ethernet-APL gateway in contexts of the connections to the field devices and the higher-level automation device.

2. The device as claimed in claim 1, where the interface for connection to the higher-level automation device of the industrial plant is configured based on PROFINET conformance class A; and wherein the interfaces for connection to the field devices are configured based on PROFINET conformance class B.

3. The device as claimed in claim 1, wherein the automation device comprises a programmable logic controller.

4. The device as claimed in claim 2, wherein the automation device comprises a programmable logic controller.

5. The device as claimed in claim 1, wherein the field devices comprise at least one of sensors and actuators.

6. The device as claimed in claim 1, wherein conditions under which an Hypertext Transfer Protocol Secure (HTTPS) connection from the automation device to the field devices is enabled are predefinable by an input via a user interface of the device.

7. The device as claimed in claim 1, further comprising:
an aggregator functionality for enabling filtering of data sent by the field devices to the automation device.

8. The device as claimed in claim 7, wherein the aggregator functionality is based on involvement of a neural network.

9. The device as claimed in claim 7, further comprising:
a controller optimization functionality for preprocessing the data sent by the field devices to the automation device in preparation for subsequent controller optimization to be performed in the automation device.

10. The device as claimed in claim 8, further comprising:
a controller optimization functionality for preprocessing the data sent by the field devices to the automation device in preparation for subsequent controller optimization to be performed in the automation device.

11. The device as claimed in claim 1, further comprising:
at least one interface configured as a current-loop interface for connection to a field device based on an electrical current with a current intensity of between 4 and 20 mA received by the field device.

12. The device as claimed in claim 11, wherein the interface for connection to the field device is configured based on the HART protocol.

13. The device as claimed in claim 1, wherein the industrial plant comprises a process or manufacturing plant.

14. An automation system having the automation device and a device as claimed in claim 1, wherein a disconnectable connection is made between the automation device and the PROFINET-based device.

15. The automation system as claimed in claim 14, further comprising:
a plurality of field devices which are disconnectably connected to corresponding interfaces of the device.

16. A method for operating an industrial plant having the device as claimed in claim 1.

17. The method as claimed in claim 16, wherein the industrial plant comprises a manufacturing or process plant.

18. A method for operating an industrial plant having the automation system as claimed in claim 14.

19. A method for operating an industrial plant having an automation system as claimed in claim 15.

20. The method as claimed in claim 18, wherein industrial plant comprises a manufacturing or process plant.

21. The method as claimed in claim 20, wherein industrial plant comprises a manufacturing or process plant.
